(19) United States
(12) Patent Application Publication
(10) Pub. No.: US 2024/0381819 A1
(43) Pub. Date: Nov. 21, 2024

(54) DRIP IRRIGATION EMITTER WITH OUTLET SUSPENSION FEATURE

(71) Applicant: The Toro Company, Bloomington, MN (US)

(72) Inventors: William C. Taylor, JR., El Cajon, CA (US); Brian D. Hu, Escondido, CA (US); Daniel Trinidad, Escondido, CA (US); David S. Martin, Bonita, CA (US); Michael R. Knighton, Lakeside, CA (US)

(73) Assignee: The Toro Company, Bloomington, MN (US)

(21) Appl. No.: 18/694,075

(22) PCT Filed: Oct. 19, 2022
(86) PCT No.: PCT/US2022/047158

§ 371 Date: Mar. 21, 2024

Related U.S. Application Data
(60) Provisional application No. 63/274,758, filed on Nov. 2, 2021.

(51) Int. Cl. A01G 25/02

(52) U.S. Cl. CPC A01G 25/023

(57) ABSTRACT

An emitter (200B) comprises an inlet section, at least one pressure reducing section, and an outlet section. The inlet section includes inlet features defining inlet apertures in fluid communication with a lateral flow path. The at least one pressure reducing section is in fluid communication with the inlet section, and the at least one pressure reducing section includes resistance features configured and arranged to reduce pressure in irrigation water flowing through the at least one pressure reducing section. The outlet section is in fluid communication with the at least one pressure reducing section and an at least one outlet aperture in the lateral. The outlet section includes at least one suspension feature configured and arranged to keep any debris in suspension in the irrigation water so that it flows (221) out the at least one outlet aperture with the irrigation water.

### CROSS-REFERENCE TO RELATED APPLICATIONS

This application claims the benefit of U.S. Provisional Patent Application Ser. No. 63/274,758, filed Nov. 2, 2021, entitled OUTLET SUSPENSION FEATURE FOR DRIP IRRIGATION EMITTER.

### BACKGROUND

Drip irrigation laterals, hoses, or tapes, including emitters, are commonly used in agricultural irrigation where the water quality is poor. The terms lateral, hose, and tape may be used interchangeably herein. The emitters can clog when small particles or debris in the irrigation water get trapped in the emitters, and the clogged emitters become less effective or dysfunctional until they are flushed or replaced, which is time consuming. In addition, inconsistent water pressure can result in clogging and/or inconsistent dispensing of the irrigation water along the length of the irrigation laterals.

In many types of prior art irrigation laterals, clogging typically occurs in the pressure reducing or pressure responsive sections of the emitters, especially for irrigation laterals with relatively low flow rates, such as drip irrigation laterals. This occurs because within these sections are most typically the smallest flow area dimensions within an emitter as necessitated by the need to dissipate pressure within a given overall emitter length. Extensive development and invention has occurred within the drip irrigation industry in order to establish geometries optimized to specifically improve clogging resistance within the pressure reducing or pressure responsive sections. Similarly extensive development and invention has occurred with design of inlet sections to provide filtration intended to protect against passage of debris. Therefore, because it was known that the features within the pressure reducing or pressure responsive sections were the cause, or potential cause, of clogging, emitter designers utilized outlet sections that did not include such features to reduce the chance of additional clogging opportunities. With reducing water supplies, such as ground water wells with limited capacity, drip irrigation users are shifting toward lower and lower emitter flow rates. Although less of an issue at higher emitter flow rates, with introduction of lower flow rates, the outlet section resistance against clogging has become a limiting factor and an area of emitter design that previously avoided inclusion of features as a countermeasure against clogging based upon perceived adverse impact of their inclusion.

For the reasons stated above and for other reasons stated below, which will become apparent to those skilled in the art upon reading and understanding the present specification, there is a need in the art for an outlet suspension feature for drip irrigation emitters.

### SUMMARY

The above-mentioned problems associated with prior devices are addressed by embodiments of the disclosure and will be understood by reading and understanding the present specification. The following summary is made by way of example and not by way of limitation. It is merely provided to aid in understanding some of the aspects of the invention.

In one embodiment, an emitter for use with a lateral to form a drip irrigation lateral comprises an inlet section, at least one pressure reducing section, and an outlet section. The lateral has a lateral wall with an inner wall surface. At least a first portion of the lateral wall defines a lateral flow path and at least a second portion of the lateral wall defines at least one outlet aperture. The inlet section is in fluid communication with the lateral flow path, and the inlet section includes inlet features defining inlet apertures. The inlet features are configured and arranged to filter at least some debris from irrigation water entering the inlet apertures. The at least one pressure reducing section is in fluid communication with the inlet section, and the at least one pressure reducing section includes resistance features configured and arranged to reduce pressure in the irrigation water flowing through the at least one pressure reducing section. The outlet section is in fluid communication with the at least one pressure reducing section and the at least one outlet aperture. The inlet section, the at least one pressure reducing section, the outlet section, and a portion of the lateral wall define an emitter flow path through which the irrigation water flows. The outlet section includes at least one suspension feature configured and arranged to keep any debris in suspension in the irrigation water so that it flows out the at least one outlet aperture with the irrigation water.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. In accordance with common practice, the various described features are not drawn to scale but are drawn to emphasize specific features relevant to the present disclosure. Reference characters denote like elements throughout the Figures and the text.

FIG. 1A is a schematic view of a portion of a prior art emitter;

FIG. 1B is a schematic view of a portion of the emitter shown in FIG. 1A illustrating an emitter flow path for the emitter;

FIG. 1C is a schematic view of a portion of the emitter shown in FIG. 1A illustrating a debris field for the emitter;

FIG. 2A is a schematic view of a portion of another prior art emitter;

FIG. 2B is a schematic view of a portion of the emitter shown in FIG. 2A illustrating an emitter flow path for the emitter;

FIG. 2C is a schematic view of a portion of the emitter shown in FIG. 2A illustrating a debris field for the emitter;

FIG. 3 is a schematic view of a portion of an embodiment emitter constructed in accordance with the principles of the present invention;

FIG. 4A is a cross section view of an example construction of the emitter shown in FIG. 3 taken along the lines A-A in FIG. 3;

FIG. 4B is a cross section view of another example construction of the emitter shown in FIG. 3 taken along the lines A-A in FIG. 3;

FIG. 5A is a cross section view of an example construction of the emitter shown in FIG. 3 operatively connected to a lateral taken along the lines A-A in FIG. 3;

FIG. 5B is a cross section view of another example construction of the emitter shown in FIG. 3 operatively connected to a lateral taken along the lines A-A in FIG. 3;

FIG. 5C is a cross section view of another example construction of the emitter shown in FIG. 3 operatively connected to a lateral taken along the lines A-A in FIG. 3;

FIG. 6A is a cross section view of an example construction of the emitter operatively connected to the lateral shown in FIG. 5A taken along the lines B-B in FIG. 5A;

FIG. 6B is a cross section view of an example construction of the emitter operatively connected to the lateral shown in FIG. 5A taken along the lines B-B in FIG. 5A;

FIG. 7A is a schematic view of a portion of another embodiment emitter constructed in accordance with the principles of the present invention illustrating an emitter flow path for the emitter;

FIG. 7B is a schematic view of a portion of the emitter shown in FIG. 7A illustrating a debris field for the emitter;

FIG. 8A is a schematic view of a portion of another embodiment emitter constructed in accordance with the principles of the present invention;

FIG. 8B is a schematic view of a portion of another embodiment emitter constructed in accordance with the principles of the present invention;

FIG. 8C is a schematic view of a portion of another embodiment emitter constructed in accordance with the principles of the present invention;

FIG. 8D is a schematic view of a portion of another embodiment emitter constructed in accordance with the principles of the present invention;

FIG. 8E is a schematic view of a portion of another embodiment emitter constructed in accordance with the principles of the present invention;

FIG. 9 is a schematic view of a portion of another embodiment emitter constructed in accordance with the principles of the present invention;

FIG. 10 is a schematic view of a portion of another embodiment emitter constructed in accordance with the principles of the present invention;

FIG. 11 is a schematic view of a portion of another embodiment emitter constructed in accordance with the principles of the present invention;

FIG. 12A is a schematic view of a portion of another embodiment emitter constructed in accordance with the principles of the present invention;

FIG. 12B is a cross section view of the emitter shown in FIG. 12A operatively connected to a lateral taken along the lines 12B-12B in FIG. 12A;

FIG. 12C is a magnified portion of the emitter and lateral shown in FIG. 12B;

FIG. 13A is a schematic view of a portion of another embodiment emitter constructed in accordance with the principles of the present invention;

FIG. 13B is a cross section view of the emitter shown in FIG. 13A operatively connected to a lateral taken along the lines 13B-13B in FIG. 13A;

FIG. 13C is a magnified portion of the emitter and lateral shown in FIG. 13B;

FIG. 14A is a schematic view of a portion of another embodiment emitter constructed in accordance with the principles of the present invention;

FIG. 14B illustrates alternate cross section views of the emitter shown in FIG. 14A operatively connected to a lateral taken along the lines 14B-14B in FIG. 14A with magnified portions of the alternate views having alternate outlet apertures in the lateral;

FIG. 15 is a schematic view of a portion of another embodiment emitter constructed in accordance with the principles of the present invention;

FIG. 16 is a schematic view of a portion of another embodiment emitter constructed in accordance with the principles of the present invention;

FIG. 17 is a schematic view of a portion of another embodiment emitter constructed in accordance with the principles of the present invention;

FIG. 18 is a schematic view of a portion of another embodiment emitter constructed in accordance with the principles of the present invention;

FIG. 19 is a schematic view of a portion of another embodiment emitter constructed in accordance with the principles of the present invention;

FIG. 20 is a schematic view of a portion of another embodiment emitter constructed in accordance with the principles of the present invention;

FIG. 21A is a schematic view of a portion of another embodiment emitter constructed in accordance with the principles of the present invention;

FIG. 21B is a cross section view of the emitter shown in FIG. 21A operatively connected to a lateral taken along the lines 21B-21B in FIG. 21A;

FIG. 21C is a magnified portion of the emitter and lateral shown in FIG. 21B;

FIG. 22 is a schematic view of a portion of another embodiment emitter constructed in accordance with the principles of the present invention;

FIG. 23 is a schematic view of a portion of a prior art emitter;

FIG. 24 is a schematic view of a portion of another embodiment emitter constructed in accordance with the principles of the present invention;

FIG. 25 is a schematic view of a portion of another embodiment emitter constructed in accordance with the principles of the present invention;

FIG. 26 is a schematic view of a portion of another embodiment emitter constructed in accordance with the principles of the present invention;

FIG. 27 is a schematic view of a portion of another embodiment emitter constructed in accordance with the principles of the present invention;

FIG. 28 is a schematic view of a portion of another embodiment emitter constructed in accordance with the principles of the present invention;

FIG. 29 is a schematic view of a portion of another embodiment emitter constructed in accordance with the principles of the present invention;

FIG. 30 is a schematic view of a portion of another embodiment emitter constructed in accordance with the principles of the present invention with an outlet aperture in a first position relative to an outlet portion of the emitter;

FIG. 31 is a schematic view of the emitter shown in FIG. 30 with an outlet aperture in a second position relative to an outlet portion of the emitter;

FIG. 32 is a schematic view of the emitter shown in FIG. 30 with an outlet aperture in a third position relative to an outlet portion of the emitter;

FIG. 33 is a schematic view of the emitter shown in FIG. 30 with an outlet aperture in a fourth position relative to an outlet portion of the emitter;

FIG. 34 is a schematic view of the emitter shown in FIG. 30 with an outlet aperture in a fifth position relative to an outlet portion of the emitter;

FIG. 35 is a schematic view of a portion of another embodiment emitter constructed in accordance with the principles of the present invention with an outlet aperture in a first region of an outlet portion of the emitter;

FIG. 36 is a schematic view of the emitter shown in FIG. 35 with an outlet aperture in a second region of the outlet portion;

FIG. 37 is a schematic view of the emitter shown in FIG. 35 with an outlet aperture in a third region of the outlet portion;

FIG. 38 is a schematic view of the emitter shown in FIG. 35 with an outlet aperture in a fourth region of the outlet portion;

FIG. 39 is a cross sectional view of an example prior art emitter; and

FIG. 40 is a view showing the prior art emitter of FIG. 39 operatively connected to an irrigation lateral.

### DETAILED DESCRIPTION

In the following detailed description, reference is made to the accompanying drawings, which form a part hereof, and in which is shown by way of illustration embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

It is to be understood that other embodiments may be utilized and mechanical changes may be made without departing from the spirit and scope of the present disclosure. The following detailed description is, therefore, not to be taken in a limiting sense.

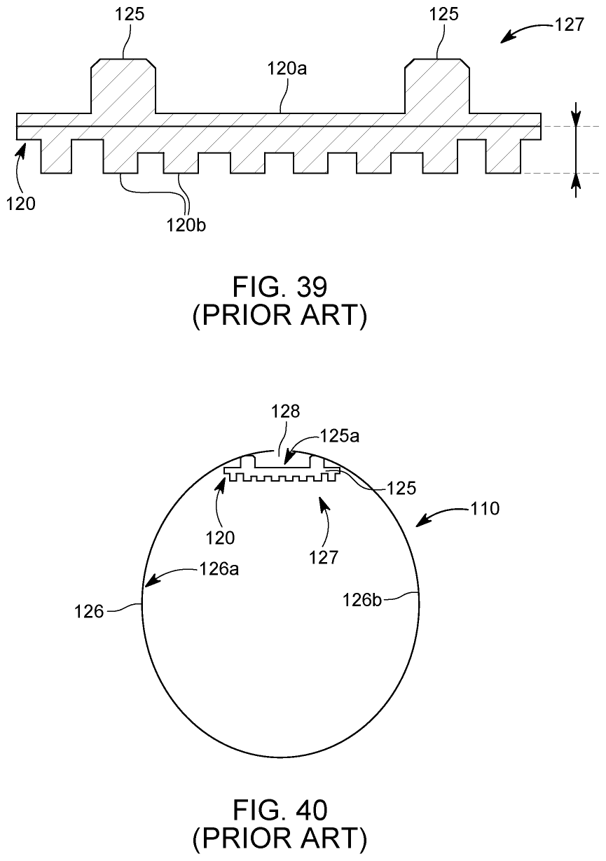

An example typical (prior art) emitter 120 is shown in FIG. 39 as a cross section and the example emitter 120 operatively connected to a lateral 126 to form an irrigation lateral 110 is shown in FIG. 40. Although FIG. 39 depicts a two layer construction, it is recognized that construction could be one, two, or more than two layer(s). FIG. 40 shows the lamination of a substrate 120 (emitter) with rails 125 on an inner wall 126a of the lateral 126, thereby forming the irrigation lateral 110. The inner wall 126a forms the main water passageway through the lateral 126. A lateral flow path 126b is the path through which fluid flows through the lateral 126, and an emitter flow path 125a is the path through which fluid flows into the emitter 120, through the emitter (between the emitter 120 and the inner wall 126a of the lateral 126), and out an outlet 128 in the lateral 126. The substrate 120 may be applied as a continuous strip member 127 laminated to the lateral 126 in any suitable manner, such as that disclosed in U.S. Pat. No. 8,469,294. The continuous strip member 127 may be rolled up and stored for later insertion into the hose 110, or the continuous strip member 127 may go right from a mold wheel to the extruder for the lateral 126. That is, the lamination of the rails 125 and substrate 120 (including top surface 120a and fins 120b) from the mold wheel is positioned inside of the die head extruding the lateral 126 thereby forming the irrigation lateral 110. Suitable inlets (not shown) allow passage of water from the lateral flow path 126b into the emitter flow path 125a. Suitable outlets 128 are formed in the irrigation lateral 110 proximate the outlet section of the substrate 120, by means well known in the art.

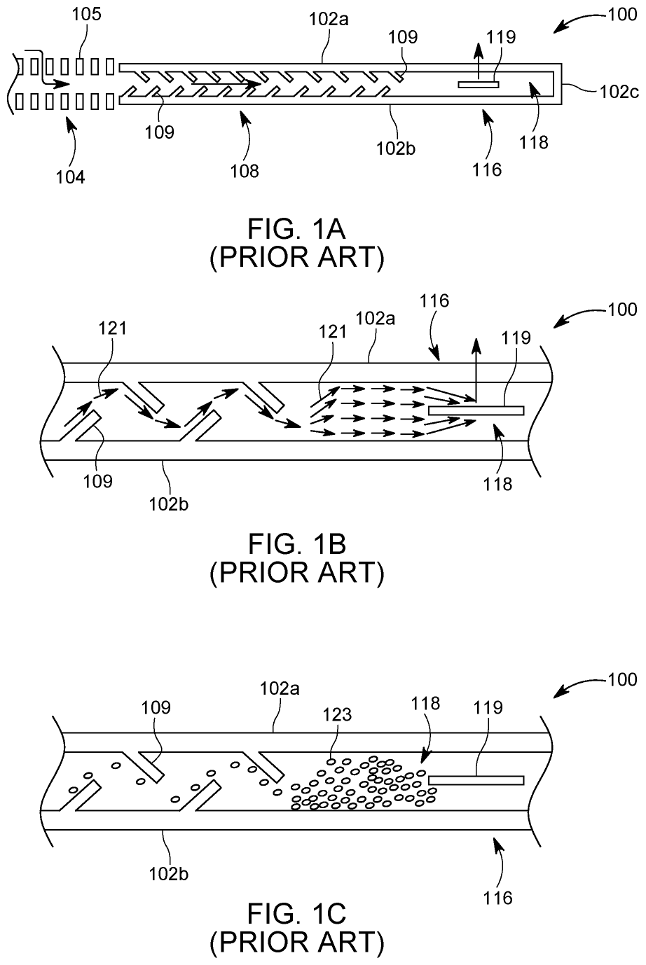

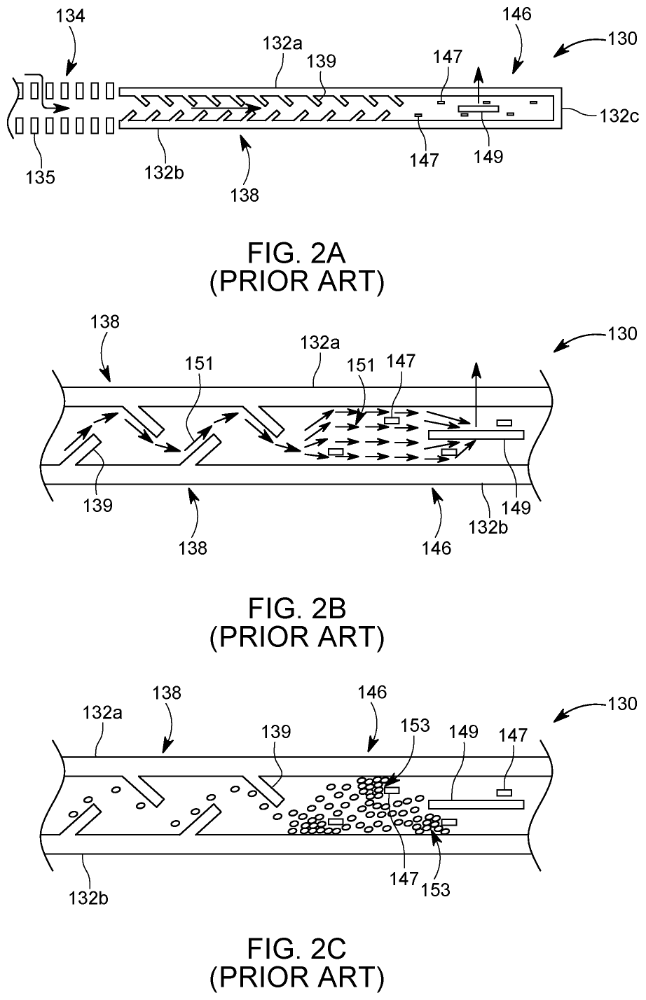

FIGS. 1A, 1, and 1C and FIGS. 2A, 2B, and 2C illustrate additional prior art emitters that are operatively connected to laterals to form irrigation laterals. Generally, prior art emitters do not include outlet section suspension features, which are a novel feature of the present invention. In FIGS. 1A, 1B, and 1C, the emitter 100 includes an inlet section 104, a pressure reducing section 108, and an outlet section 116. A pressure responsive section (not shown) could be positioned between the pressure reducing section 108 and the outlet section 116. The inlet section 104 includes inlet features 105 configured and arranged to help filter debris from irrigation water to reduce the amount of debris that enters the emitter flow path 121 via the inlet section 104. Rails 102a and 102b and termination 102c form the pressure reducing section 108 and the outlet section 116. The pressure reducing section 108 includes resistance features 109 extending from the rails 102a and 102b and configured and arranged to reduce the pressure of the irrigation water flowing through the pressure reducing section 108. The outlet section 116 includes an open area 118 and corresponds with an outlet aperture 119 formed in the lateral. A floor (not shown) interconnects the bottom surfaces of the inlet features 105, the rails 102a and 102b, and the termination 102c and the top surfaces of the inlet features 105, rails 102a and 102b, and the termination 102c are configured and arranged to operatively connect to an inner surface of the lateral thereby defining the emitter 100. FIG. 1B illustrates the path of water flow 121, and FIG. 1C illustrates a debris field 123 that represents locations within the outlet section 116 where debris could settle. Note, debris depicted in vicinity of resistance features 109 remain entrained within the flow streamlines established by the optimization of features 109 for purposes of resisting clogging.

In FIGS. 2A, 2B, and 2C, the emitter 130 includes an inlet section 134, a pressure reducing section 138, and an outlet section 146. A pressure responsive section (not shown) could be positioned between the pressure reducing section 138 and the outlet section 146. The inlet section 134 includes inlet features 135 configured and arranged to help filter debris from irrigation water to reduce the amount of debris that enters the emitter flow path 151 via the inlet section 134. Rails 132a and 132b and termination 132c form the pressure reducing section 138 and the outlet section 146. The pressure reducing section 138 includes resistance features 139 extending from the rails 132a and 132b and configured and arranged to reduce the pressure of the irrigation water flowing through the pressure reducing section 138. The outlet section 146 includes support features 147 and corresponds with an outlet aperture 149 formed in the lateral. A floor (not shown) interconnects the bottom surfaces of the inlet features 135, the rails 132a and 132b, and the termination 132c and the top surfaces of the inlet features 135, rails 132a and 132b, and the termination 132c are configured and arranged to operatively connect to an inner surface of the lateral thereby defining the emitter 130. The support features 147 are configured and arranged to keep the floor and the lateral wall at a desired distance apart thereby preventing collapse of the emitter in the outlet section 146. Support features 147 could also provide support for the lateral wall during outlet aperture formation, to prevent the opposing side from being punctured, or during in field vacuum conditions when the irrigation lateral is draining post irrigation cycle. FIG. 2B illustrates the path of water flow 151, and FIG. 2C illustrates a debris field 153 that represents locations where debris could settle within the outlet section 146. Note, debris depicted in vicinity of resistance features 139 remain entrained within the flow streamlines established by the optimization of features 139 for purposes of resisting clogging.

It has been discovered that, in prior art emitters such as emitters 100 and 130, the outlet sections can have large, open cross sectional areas (width×height) compared to the cross sectional areas of the pressure reducing sections and/or the pressure responsive sections, which results in much lower velocity (approximately 70% to 80% lower) of the irrigation water within the outlet sections thereby causing debris entrained in the irrigation water to fall out of suspension and settle in the outlet sections, eventually causing reduced flow to no flow due to blockage. In addition, for emitters including support features in the outlet sections, the support features provide locations where debris can accumulate, which eventually causes reduced or blocked flow. Reduced velocity and locations where debris can accumulate increase the chances of clogging.

Until the present invention, suspension features were not included in the outlet section because it was thought they could interfere with the function of the outlet aperture and features could create additional opportunities for clogging. Reasons suspension features were not utilized include the perception that they could interfere include obstructing flow to the outlet aperture thereby causing squirting or uneven dispensing of the irrigation water from the outlet aperture, they could stiffen the outlet section thereby preventing proper operation of the outlet aperture (e.g., slit and flap type apertures), they could lead to changes in flow rate as function of variations in outlet aperture placement, and their presence could necessitate removing material from the rails and, or floor (to create the volume of material needed for the suspension features) which could cause weakness and eventual leaks in the outlet section (e.g., thinner rails, weaker adherence of the rails to the lateral wall, a thinner floor that could rupture, etc.). It has been surprisingly discovered that inclusion of suspension features within an outlet section provides for maintaining debris in suspension in the irrigation water allows debris to pass through the outlet apertures rather than accumulating in the outlet sections thereby being more clog resistant without negatively affecting the dispensing rate of the irrigation water through the outlet aperture. It has also been surprisingly discovered that outlet aperture placement and suspension feature configuration alleviates any interference with outlet aperture function.

Embodiment emitters of the invention generally include a base or floor with outwardly extending rails and features to form inlet sections, pressure reducing sections, and outlet sections. Optionally, pressure responsive sections may interconnect the pressure reducing sections and the outlet sections. Optionally, the pressure reducing sections may include at least one pressure responsive element such as but not limited to inclusion of elastomeric material to enable changes in dimension in response to changes in pressure. Whereas a function of a pressure reducing section is to dissipate the differential pressure existing between the inlet and outlet sections, if a pressure responsive section is present, it functionally accomplishes a portion of this differential pressure dissipation. For this reason, it is apparent that references herein to pressure reducing section could also include a combination of pressure reducing and pressure responsive elements. The emitters form cavities with the lateral wall to form emitter flow paths. The pressure reducing sections include middle portions between first rails and second rails. In some embodiments, the first and second rails extend into and through the outlet sections and are interconnected with end rails to terminate the outlet sections. The lateral wall includes an outlet aperture through which the irrigation water is dispensed. The outlet apertures can be any suitable opening in the lateral such as laser or mechanically formed slots, slits, holes, flaps, etc. It is recognized that suitable emitter designs could be used with the present invention. The term emitter includes a continuous emitter design, an intermittent strip emitter design, a hot melt emitter design, a discrete emitter design, an in-seam emitter design, and other suitable emitter designs. The emitter can be made of elastomeric materials, non-elastomeric materials, or a combination thereof.

Embodiments of emitters are illustrated schematically in the drawings. It is understood that floors interconnect the various features and rails and that outlet apertures are part of the lateral wall. A person having ordinary skill in the art will appreciate that various emitter components have suitable thicknesses. Suitable thicknesses could range from 0.004 to 0.048 inch.

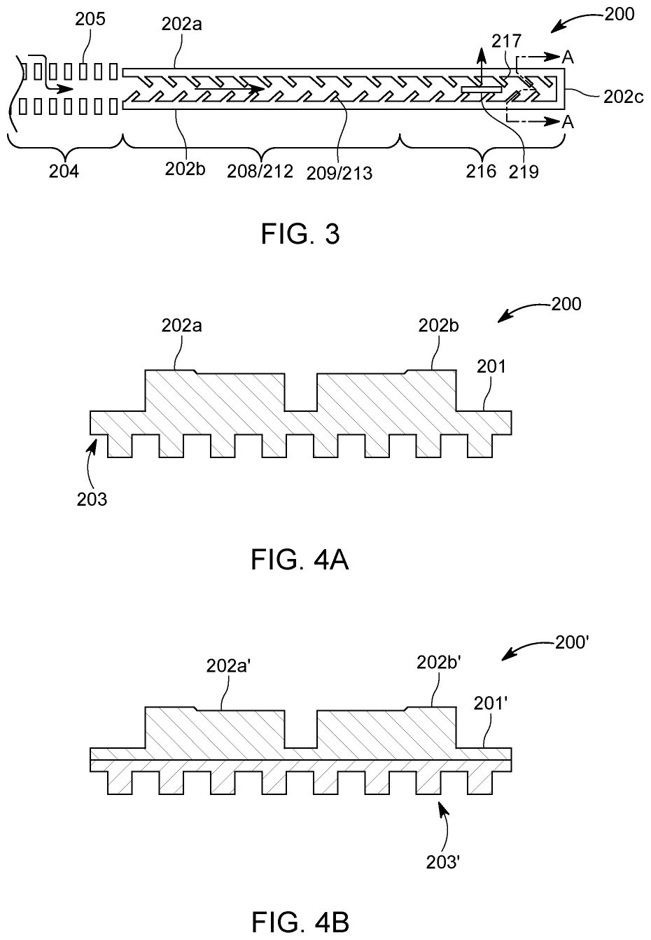

In one embodiment, illustrated in FIGS. 3, 4A, and 5A, an emitter 200 includes an inlet section 204, a pressure reducing section 208 and/or a pressure responsive section 212, and an outlet section 216. A floor 201 interconnects rails 202a and 202b, an end portion 202c interconnecting distal ends of the rails 202a and 202b, and various features; and at least the rails 202a and 202b and the end portion 202c are configured and arranged to connect to the inner wall 228 of the lateral 227 to form an irrigation lateral 226. Optional fins 203 can extend downward from the floor 201 to help filter/direct any debris in the irrigation water flowing through the later flow path 229. The inlet section 204 includes inlet features 205 configured and arranged to allow irrigation water to enter the inlet section 204 while filtering at least some of the debris from entering the inlet section 204. The pressure reducing section 208 and/or the pressure responsive section 212 include(s) resistance features 209 and/or tuning features 213, respectively, to dissipate the differential pressure existing between the inlet and outlet sections. The outlet section 216 includes suspension features 217 configured and arranged to keep any debris in suspension in the irrigation water within the outlet section 216 so that the debris flows out the outlet aperture 219 of the lateral 227 with the irrigation water rather than settling in the outlet section 216.

These embodiments illustrate that the emitter can include a single layer construction, a double layer construction, or a multiple layer construction. Each layer can comprise one or more material(s). The emitter can be a discrete emitter, a continuous strip emitter (a plurality of interconnected emitters), or an intermittent strip emitter. Similarly, the laterals can include one or more layer(s) of one or more material(s). The emitters can be used with any suitable lateral such as an overlapping lateral, a seamless lateral, and a seamed wall lateral. The emitters can be operatively connected to the laterals in any suitable matter.

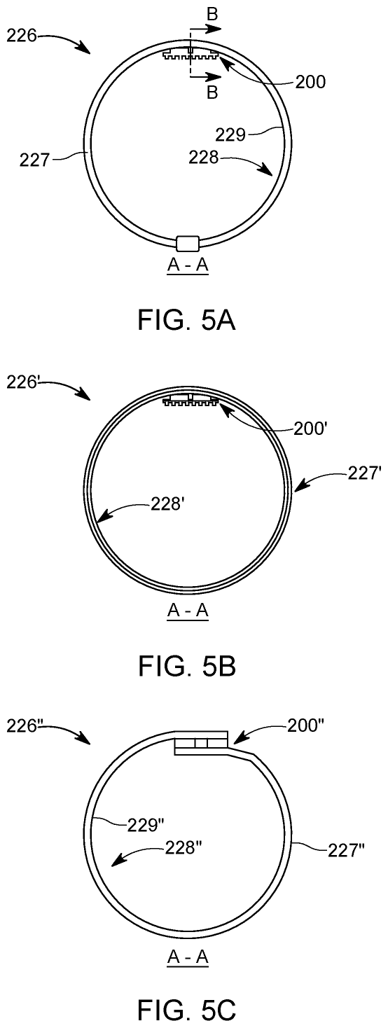

FIGS. 4A and 4B are cross sections of example emitters 200 and 200′ taken along the lines A-A in FIG. 3 and FIGS. 5A, 5B, and 5C are cross sections of example irrigation laterals 226, 226′, and 226″ taken along the lines A-A in FIG. 3. In FIG. 4A, the emitter 200 is illustrated as a single layer construction, which can include one or more materials. In FIG. 4B, the emitter 200′ is illustrated as a two layer construction, and each layer can include one or more materials. In emitter 200′, the floor 201′ and the rails 202a′ and 202b′ are a first layer and the fins 203′ are a second layer. It is recognized that one or more layers, each layer comprising one or more materials, can be used.

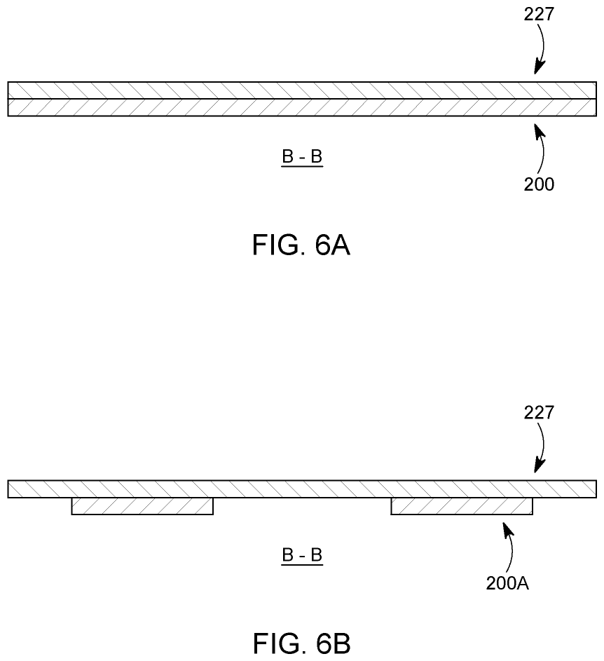

These embodiments illustrate that different types of laterals can also be used with the present invention. For example, in FIG. 5A, a seamed wall lateral 227 is used. The emitter, for example emitter 200, is operatively connected to an inner wall 228 of the lateral 227. The inlet section 204 of the emitter 200 is in fluid communication with the lateral flow path 229. Another example lateral is shown in FIG. 5B. A seamless wall lateral 226′ is shown, and the emitter, for example emitter 200′, is operatively connected to an inner wall 228′ of the lateral 227′. Another example lateral is shown in FIG. 5C. An overlapping wall lateral 226″ is shown, and the emitter, for example emitter 200″, is operatively connected between overlapping layers of the lateral. In this example, one side of the emitter 200″ includes inlet features that are in fluid communication with the lateral flow path 229″. As shown in FIGS. 6A and 6B, which are cross sections taken along the lines B-B in FIG. 5A as alternate examples, the emitters can be continuous strip emitters, emitter 200 in FIG. 6A, or discrete emitters, emitter 200A in FIG. 6B.

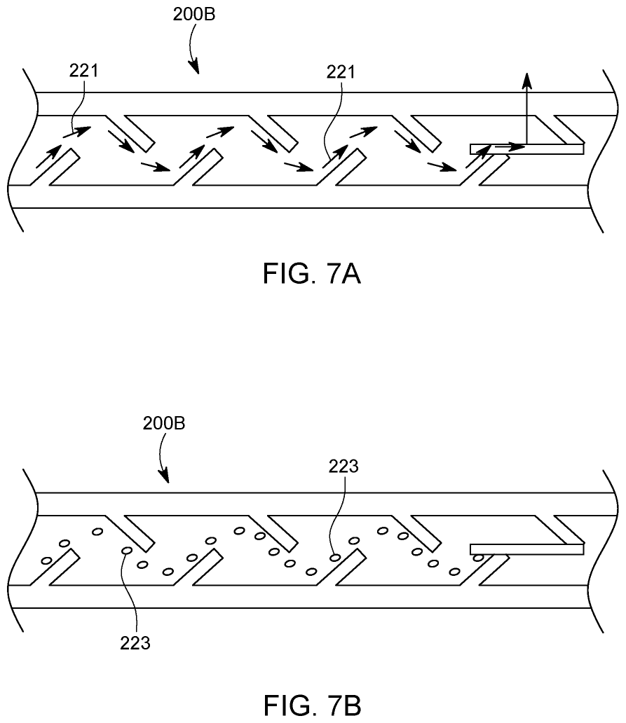

FIGS. 7A and 7B illustrate an emitter 200B, which is similar to emitter 200, and its path of water flow 221 and its debris 223 entrained within flow “streamlines” in the outlet section. The outlet section includes suspension features, which create a nonlinear flow path with a relatively high velocity for the irrigation water, thereby keeping any debris in suspension and reducing settling of debris. The arrows illustrating the path of water flow 221 generally illustrate the flow of the irrigation water, including any debris, through the outlet section. The debris field 223 generally illustrates the primary debris is entrained within the path of water flow 221, whereby the amount of debris that settles in the outlet section is greatly reduced.

These embodiments illustrate that configuration of the outlet section can vary. Suspension features can have a variety of configurations in the outlet section. The suspension features can have tips that are coincident with a longitudinal axis or centerline of the emitter, tips that do not extend to the centerline, tips that extend beyond the centerline, overlapping opposing tips, coincident opposing tips, and opposing tips that do not extend to each other and form gaps. The angles from which the suspension features extend from the rails can also vary. The suspension features can also be incorporated into nonlinear rail portions. The suspension features can also fully contact, partially contact, or gap in relationship with the lateral inner wall or in relationship to outlet section rails. A leading edge or termination of the outlet section can have a nonlinear shape. Placement features positioned within the outlet section can also be used. The width along a length of the outlet section can vary. In addition, placement of the outlet aperture relative to the outlet section and configuration of the outlet aperture can vary.

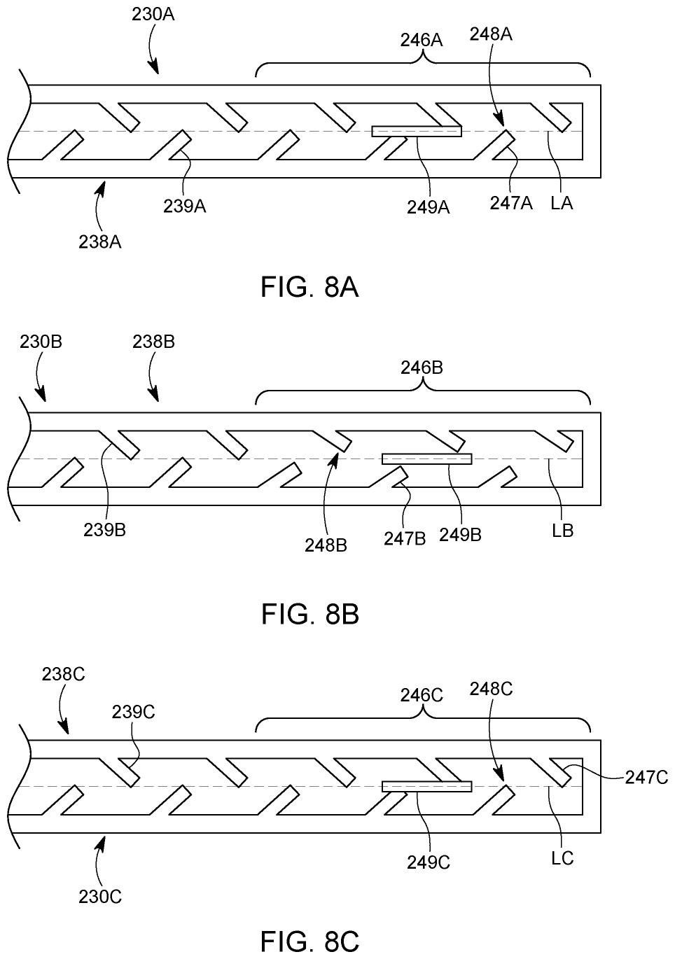

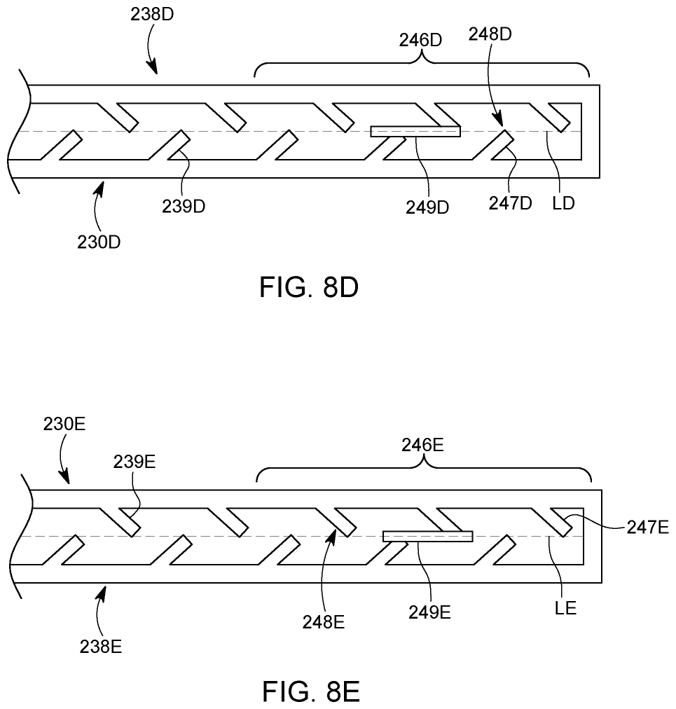

A portion of an embodiment emitter 230A is illustrated in FIG. 8A. A portion of a pressure reducing section 238A including resistance features 239A is in fluid communication with an outlet section 246A including suspension features 247A. An outlet aperture 249A in a lateral is in fluid communication with the outlet section 246A. Tips 248A of the suspension features 247A are coincident with the emitter centerline LA, extending to the centerline LA, in this embodiment. Also, the tips 248A of opposing suspension features 247A are coincident with each other, extending similarly to the centerline LA.

A portion of an embodiment emitter 230B is illustrated in FIG. 8B. A portion of a pressure reducing section 238B including resistance features 239B is in fluid communication with an outlet section 246B including suspension features 247B. An outlet aperture 249B in a lateral is in fluid communication with the outlet section 246B. Tips 248B of the suspension features 247B are not coincident with the emitter centerline LB and opposing tips 248B are not coincident with each other thereby forming gaps therebetween.

A portion of an embodiment emitter 230C is illustrated in FIG. 8C. A portion of a pressure reducing section 238C including resistance features 239C is in fluid communication with an outlet section 246C including suspension features 247C. An outlet aperture 249C in a lateral is in fluid communication with the outlet section 246C. Tips 248C of the suspension features 247C are not coincident with the emitter centerline LC but rather extend beyond the centerline LC and opposing tips overlap each other relative to the centerline LC.

A portion of an embodiment emitter 230D is illustrated in FIG. 8D. A portion of a pressure reducing section 238D including resistance features 239D is in fluid communication with an outlet section 246D including suspension features 247D. An outlet aperture 249D in a lateral is in fluid communication with the outlet section 246D. Some of tips 248D of the suspension features 247D are coincident with the emitter centerline LD and some are not coincident with the emitter centerline LD so that opposing tips 248D either are coincident with each other or form gaps.

A portion of an embodiment emitter 230E is illustrated in FIG. 8E. A portion of a pressure reducing section 238E including resistance features 239E is in fluid communication with an outlet section 246E including suspension features 247E. An outlet aperture 249E in a lateral is in fluid communication with the outlet section 246E. Some of tips 248E of the suspension features 247E are coincident with the emitter centerline LD and some are not coincident with the emitter centerline LD, and some opposing tips 248E extend beyond each other and some are coincident with each other.

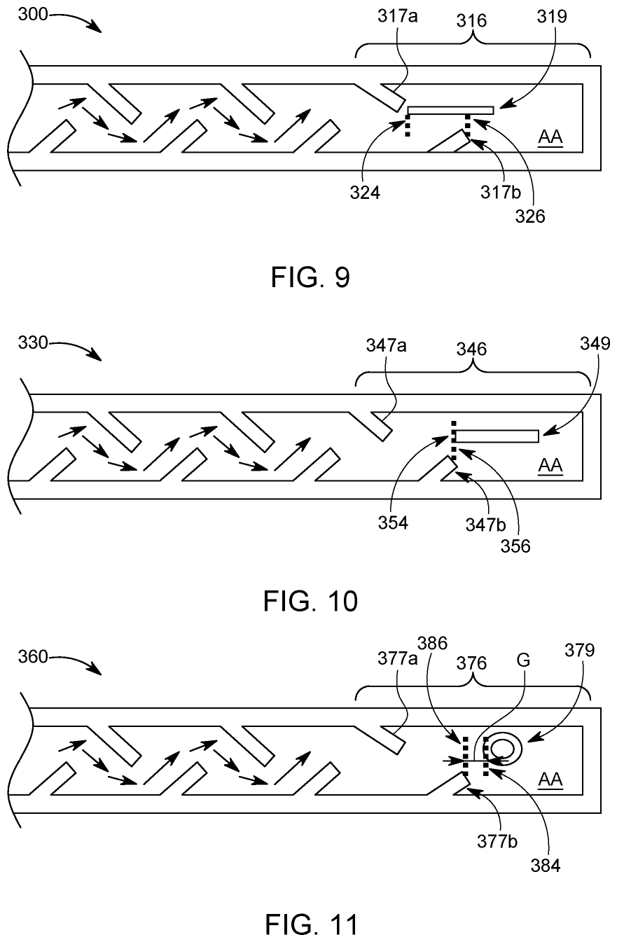

Embodiments illustrate that outlet apertures do not have to be centered relative to a centerline of the emitter or to a centerline of the suspension features. FIGS. 9, 10, and 11 illustrate emitters with different configurations of outlet apertures in different locations in the outlet section. Emitter 300, shown in FIG. 9, includes an outlet section 316 with suspension features 317a and 317b and an outlet aperture 319. The outlet aperture 319, which is a slit, includes an upstream edge 324, which is upstream of, not coincident with, a downstream edge 326 of the final downstream suspension feature 317b. Emitter 330, shown in FIG. 10, includes an outlet section 346 with suspension features 347a and 347b and an outlet aperture 349. The outlet aperture 349, which is a slot, includes an upstream edge 354, which is coincident with a downstream edge 356 of the final downstream suspension feature 347b. Emitter 360, shown in FIG. 11, includes an outlet section 376 with suspension features 377a and 377b and an outlet aperture 379. The outlet aperture 379, which is a hole, includes an upstream edge 384 that is downstream of, not coincident with, a downstream edge 386 of the final downstream suspension feature 377b. In this example, dimension G is preferably 5 mm or less, and more preferably, 2 mm or less for 0.25 lph (liters per hour) emitter flow rate, 3 mm or less for 0.50 lph flow rate, 4 mm or less for 0.75 lph flow rate, and 5 mm or less for 1.00 lph flow rate. In addition, in these examples, indicia AA can be included in the outlet section to indicate mold number, flow rate, or other desirable characteristics and, therefore, it may be desirable to include a portion free of suspension features.

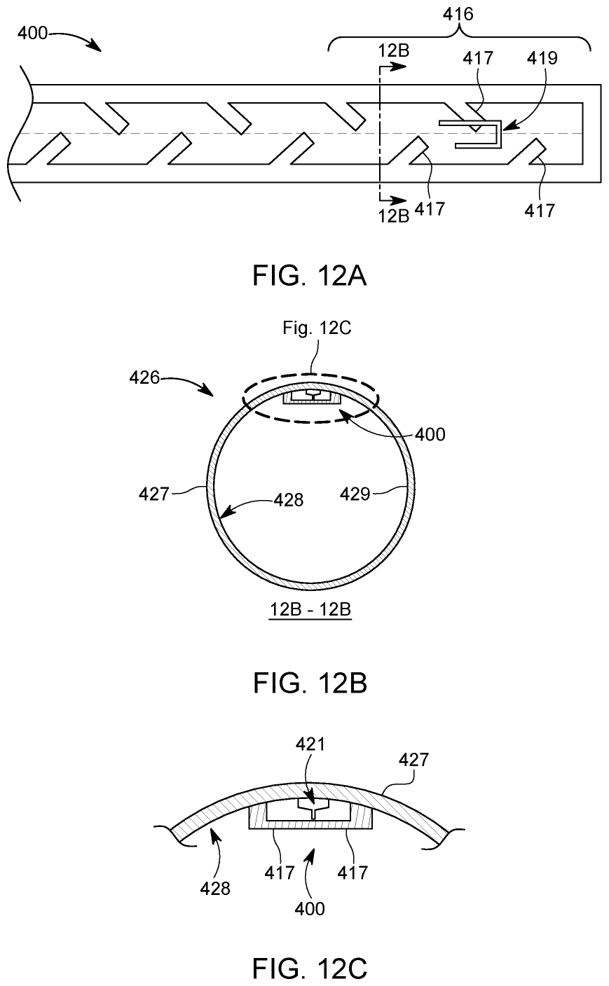

A portion of an embodiment emitter 400 is illustrated in FIGS. 12A, 12B, and 12C. In this embodiment, as shown in FIG. 12A, an outlet section 416 includes suspension features 417 and an outlet aperture 419. As shown in FIG. 12B, a cross section taken along the lines 12B-12B in FIG. 12A, an irrigation lateral 426 includes the emitter 400 operatively connected to an inner wall 428 of a lateral 427 defining a lateral flow path 429. The emitter 400 and the lateral 427 define an emitter flow path 421. As shown in FIG. 12C, the suspension features 417 have portions that do not contact the inner wall 428 of the lateral 427. The suspension features could be at least partially separate from the inner wall of the lateral, forming a gap. One benefit to having a gap is that flap-style outlet apertures, like outlet aperture 419, can be used without affecting their function.

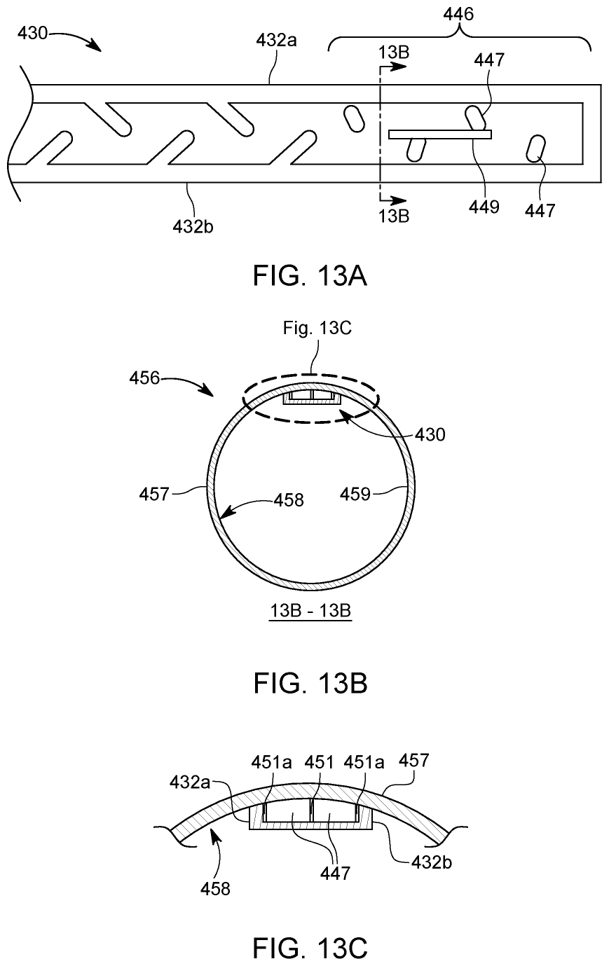

A portion of an embodiment emitter 430 is illustrated in FIGS. 13A, 13B, and 13C. In this embodiment, as shown in FIG. 13A, an outlet section 446 includes suspension features 447 and an outlet aperture 449. The suspension features 447 can be arranged with different angles, as shown, and it is recognized that the suspension features could also have different shapes, dimensions, orientations, etc. As shown in FIG. 13B, a cross section taken along the lines 13B-13B in FIG. 13A, an irrigation lateral 456 includes the emitter 430 operatively connected to an inner wall 458 of a lateral 457 defining a lateral flow path 459. The emitter 430 and the lateral 457 define an emitter flow path 451, through which a majority of irrigation water flows. As shown in FIG. 13C, the suspension features 447 have portions that do not contact the rails 432a and 432b to form gaps 451a, through which a relatively small amount of irrigation water can flow. One benefit to having gaps between the suspension features 447 and the rails 432a and 432b is, when the emitter includes more than one layer and/or more than one material, it assists with mold filling. In this example, the outlet aperture 449 is a slot formed by removing material via a laser or other suitable means.

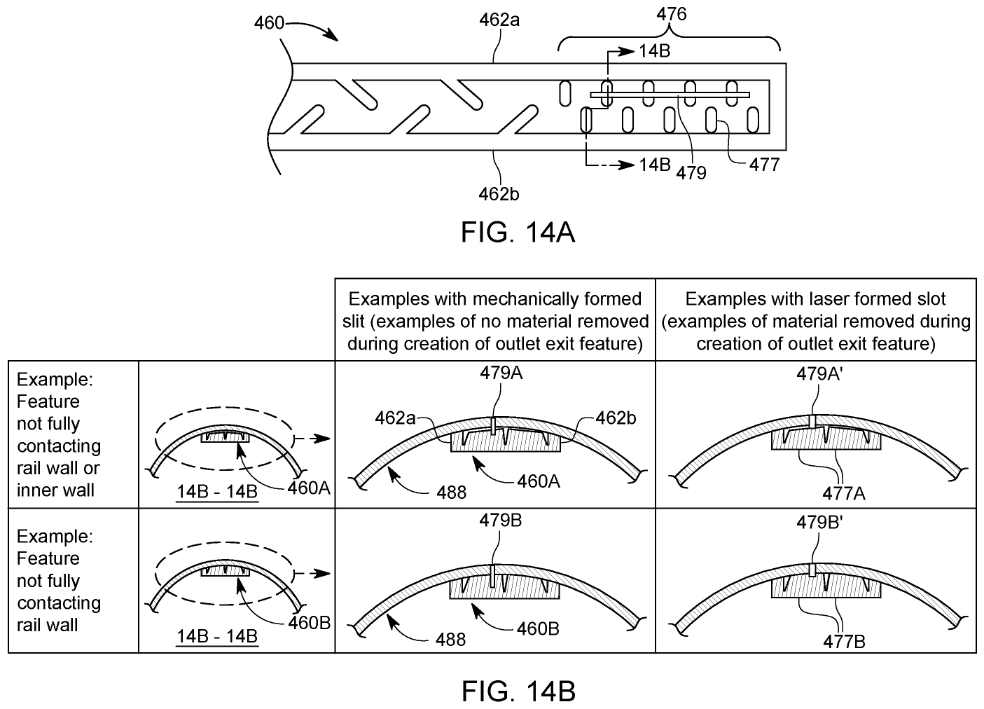

A portion of an embodiment emitter 460 is illustrated in FIGS. 14A and 14B. In this embodiment, an outlet section 476 includes suspension features 477 and an outlet aperture 479. The suspension features 477 have portions that do not contact the rails 462a and 462b and opposing suspension features 477 form gaps proximate the centerline of the emitter. The outlet aperture 479 is offset relative to the centerline of the emitter and can extend into the suspension feature(s) 477. FIG. 14B illustrates alternative embodiments, emitters 460A and 460B, as cross sections taken along the lines 14B-14B in FIG. 14A. For emitter 460A, the suspension features 477A have portions that do not contact the rails 462a and 462b and portions that do not contact the inner wall 488. The outlet aperture can either be a slit 479A, with no material removed, or a slot 479A′, with material removed. Because portions of the suspension features do not contact the inner wall of the lateral, the lateral wall can deflect to more fully open the outlet aperture. If the outlet aperture extends into the suspension feature(s), the suspension feature(s) are less stiff and can deflect to further assist in opening the outlet aperture in the lateral. For emitter 460B, the suspension features 477B have portions that do not contact the rails. The outlet aperture can either be a slit 479B or a slot 479B′. These examples further illustrate that suspension features can differ in geometry, dimension, or interval as compared to features in pressure reducing or pressure responsive sections.

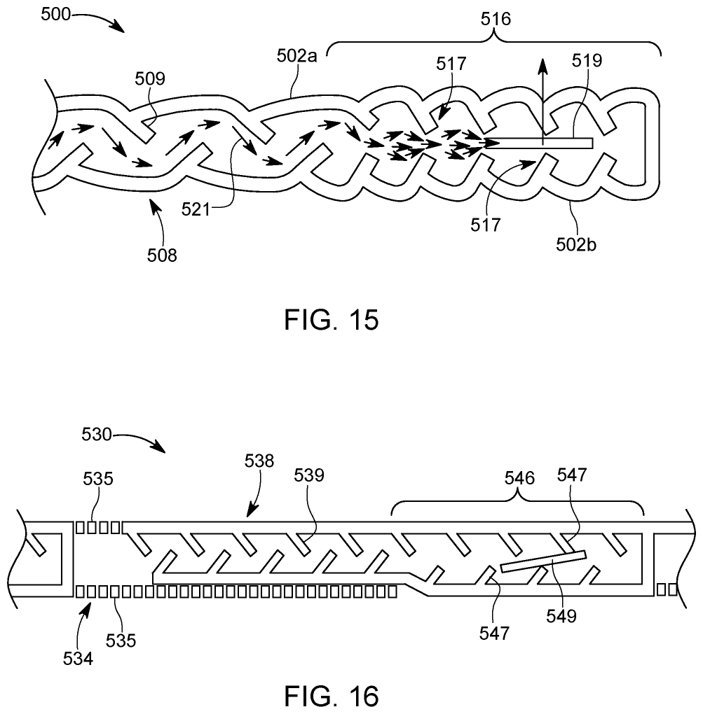

In another example emitter 500, shown in FIG. 15, the rails 502a and 502b are nonlinear and portions extending from the rails form resistance features 509 in a pressure reducing (or pressure responsive) section 508 and suspension features 517 in an outlet section 516. The distances between adjacent features can vary, and opposing features can be staggered or aligned. As illustrated in FIG. 15, when the opposing features are staggered in the pressure reducing section 508, the flow is nonlinear, and when the opposing features are aligned in the outlet section 516, the flow is linear toward the outlet aperture 519. In addition, at least one portion of the outlet section can differ in width to at least another portion of the outlet section and or another portion of the pressure reducing section.

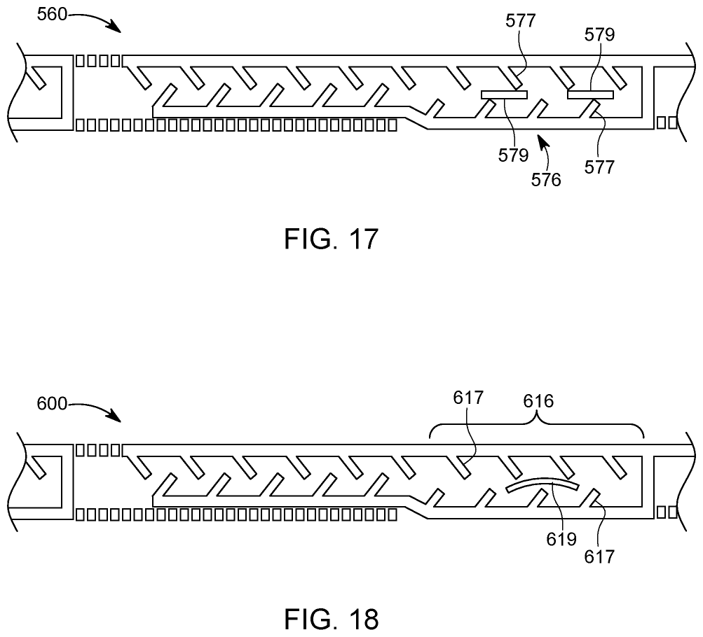

The introduction of suspension features in the outlet section creates a potential for coefficient of variation to be introduced for flow rates due to variations in outlet aperture placement (i.e. if the suspension feature resistance to flow is large and the outlet aperture placement varies highly in the emitter axial direction, then the total emitter resistance will vary as the number of suspension features upstream of the outlet aperture varies, and flow can vary from one emitter to another). Embodiments to alleviate this are illustrated in FIGS. 16, 17, and 18, which utilize larger gaps between tips of suspension features on opposing sides. The gaps have been identified as one method to decrease the flow resistance of suspension features enough to eliminate out of tolerance emitter flow coefficient of variation due to outlet aperture placement variation. Additional methods to reduce suspension feature resistance to flow include changes in feature dimensions, shapes, angles, and interval. Additionally as illustrated within FIGS. 16, 17, and 18, use of suspension features within outlet sections can include embodiments with outlet section centerline offset from pressure reducing section centerline, outlet section width differing from pressure reducing section, and also with varying quantities, shapes, and orientations of outlet apertures. Emitter 530, shown in FIG. 16, includes an inlet section 534 with inlet features 535, a pressure reducing section 538 with resistance features 539, and an outlet section 546 with suspension features 547. The outlet aperture 549 is formed in the lateral at an angle relative to the centerline of the emitter. The centerline of the emitter is defined by at least one of the pressure reducing and/or pressure responsive section(s) or the outlet section. In emitter 560, shown in FIG. 17, more than one outlet aperture 579 is formed in the lateral between suspension features 577 in the outlet section 576. In this example, two outlet apertures have similar configurations and are positioned in tandem. Other quantities of apertures and other comparative placement arrangements could be used. In emitter 600, shown in FIG. 18, a nonlinear (curved) outlet aperture 619 is positioned between opposing suspension features 617 within the outlet section 616. Other nonlinear apertures could be used. These examples also illustrate that at least a portion of the outlet section can have a different width than other section(s) of the emitter.

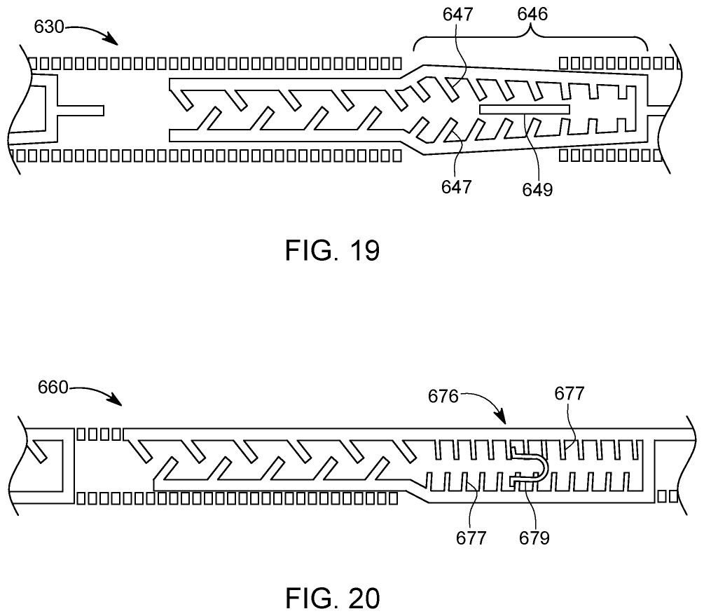

Embodiments illustrate that the suspension features can differ in angles, configurations, and intervals from features in at least one other emitter section. In addition, at least one portion of an emitter rail can be nonparallel to at least another portion of either the same emitter rail or an opposing emitter rail. For example, in FIG. 19, an emitter 630 includes an outlet section 646 that widens proximate the pressure reducing section and then slightly tapers proximate its distal end. The suspension features 647 are angled toward the outlet aperture 649 proximate the pressure reducing section and then become more perpendicular to the centerline proximate its distal end. In another example, shown in FIG. 20, when a flap-type outlet aperture 679 is used, it can be useful to increase the density of suspension features 677 to provide an underlying series of supports to serve as an anvil. In addition, it can be useful for the upper surface of the suspension features to be near but not bonded to the inner wall of the lateral.

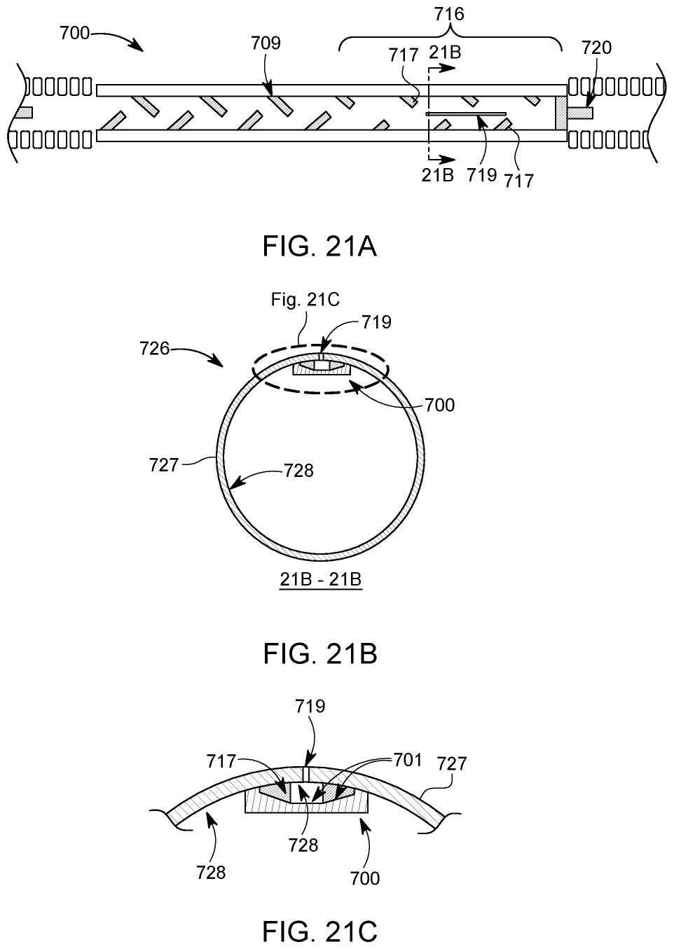

FIGS. 21A, 21B, and 21C illustrate a portion of an emitter 700 with an outlet section 716 including suspension features 717 and an outlet aperture 719 in the lateral proximate the outlet section 716. Resistance features 709, suspension features 717, and the leading edge or outlet termination 720 are shaded in these figures to illustrate that they could be made of different materials and/or formulations. As shown in the cross section views illustrated in FIGS. 21B and 21C, taken along the lines 21B-21B in FIG. 21A, rails of the emitter 700 are operatively connected to an inner wall 728 of a lateral 727 thereby forming an irrigation lateral 726, and the emitter 700 includes a floor 701 that is contoured to be lower proximate the centerline of the emitter and higher proximate the rails. For example, when using a mechanical device such as a knife or blade to create the outlet aperture 719 as a slit, the contoured floor provides additional clearance between the lateral and the emitter so that the emitter (floor) is not weakened or punctured by the knife or blade. An increased distance between the lateral and the emitter can aggravate a reduction in flow velocity that occurs in the outlet section, but the contoured floor and the inclusion of the suspension features 717 help alleviate this. In this example, the emitter includes more than one layer, the shaded portions differing in material and/or formulation compared to the other portions. Therefore, in this example two or more materials and/or formulations could be used.

For current state of the art emitter production, a vision-based or reflection-based system is used to discern a “silent” or “pattern-less” area available for placement of the outlet aperture. An outlet section leading edge could also be used. Upon discerning the open area and/or outlet section leading edge, the control loop fires or triggers (e.g., a laser formed slot) or trims control loop timing (e.g., a blade formed slit) as applicable to position the outlet aperture within the area. Additionally, with some systems, these detections also perform a quality assurance check of the outlet aperture position relative to the borders of the outlet section after the outlet aperture has been created.

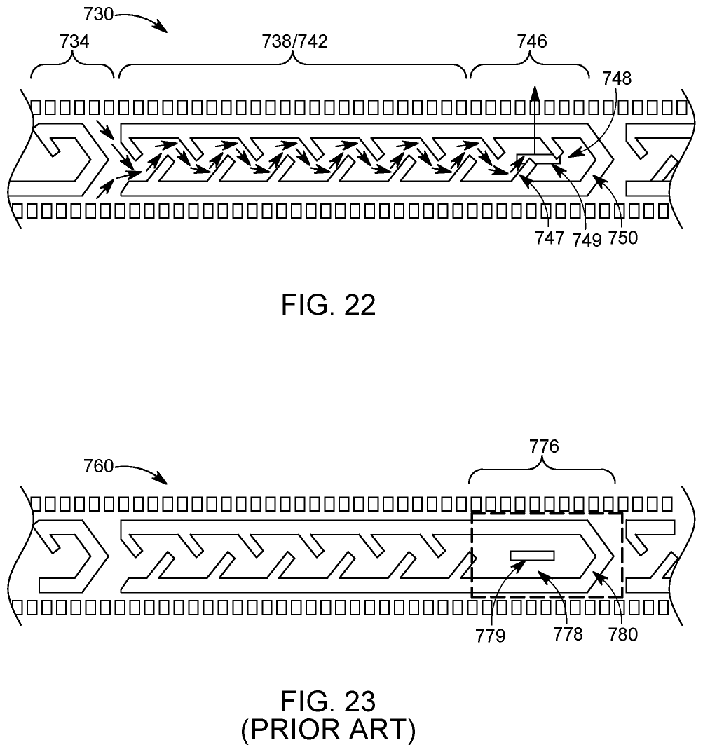

In some embodiments, maintaining a small gap between the top of the suspension features and the inner wall of the lateral can maintain the appearance of an open area when viewed on the outside. However, some embodiments have full contact between the suspension features and the inner wall thereby eliminating the appearance of an open area when viewed on the outside. Higher performing vision or reflection based systems are capable of properly placing the outlet aperture even when the suspension features are present. However, the cost of such systems and of the training required to accomplish such detection can be high. To improve system reliability and allow use of less capable detection systems, additional trigger features can be used. Example trigger features are illustrated in FIGS. 22-26. Trigger features help indicate where outlet apertures should be positioned in the lateral relative to the outlet section of the emitter.

A prior art emitter 760 with a trigger feature is illustrated in FIG. 23. The emitter 760 is similar to prior art emitters with a large open area 778 spanning the outlet section 776 and a leading edge 780 to indicate placement of the outlet aperture 779 (i.e. depending upon the system used, the presence of the large open area 778 can be used to trigger/trim outlet aperture formation, or the presence of leading edge 780 can be used to trigger/trim, or combination of 778 and 780). An embodiment emitter 730, shown in FIG. 22, includes an inlet section 734, a pressure reducing section 738 and/or a pressure responsive section 742, and an outlet section 746 including suspension features 747. The distal end of the outlet section 746 includes a leading edge 750, which includes an angle. The angle of the leading edge 750 and a relatively small open area 748 proximate the distal end of the outlet section 746 provide indication where the outlet aperture 749 should be positioned in the lateral. The outlet aperture 749 is positioned proximate the suspension features 747.

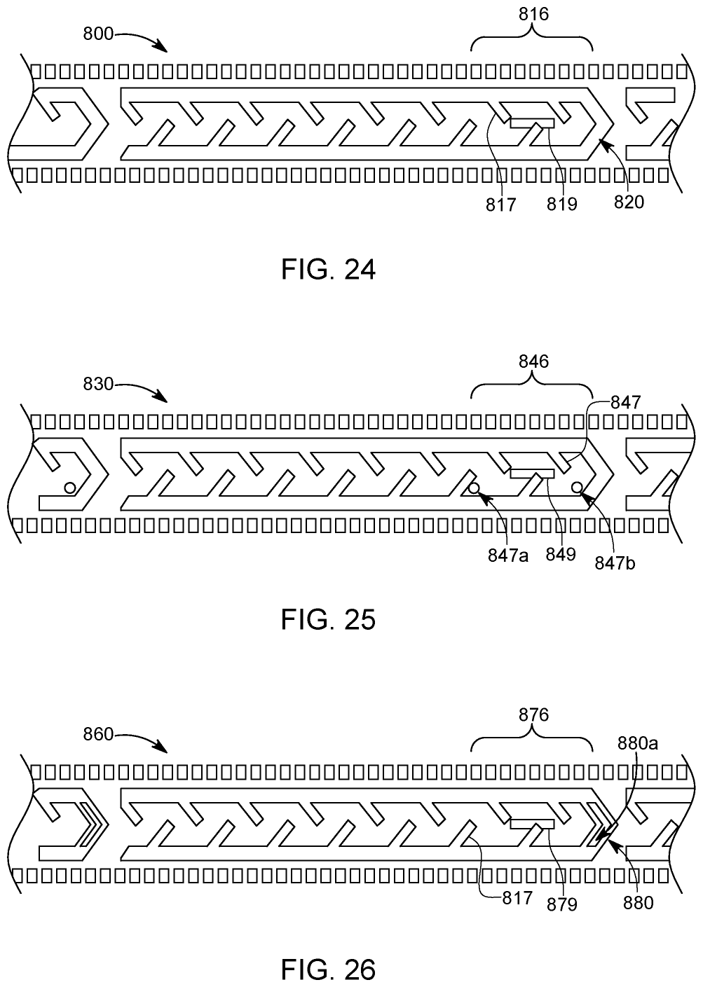

An embodiment emitter 800, shown in FIG. 24, is similar to emitter 730 but with a different position of the outlet aperture 819 relative to the suspension features 817 and the leading edge 820 of the outlet section 816. An embodiment emitter 830, shown in FIG. 25, is similar to emitter 800 but with placement features 847a and 847b, which indicate a position therebetween for the outlet aperture 849. Alternatively, either one or both of placement features 847a and 847b could be used. The outlet aperture 849 is positioned proximate the suspension features 847 in the outlet section 846. An embodiment emitter 860, shown in FIG. 26, is similar to emitter 800 but with a placement feature 880a, which corresponds with the leading edge 880 of the outlet section 876, being generally parallel thereto, to indicate a position for the outlet aperture 879. A “double” leading edge, including placement feature 880a and leading edge 880, which can be thinner than just a leading edge, is an alternative to using a leading edge as a placement feature. The outlet aperture 879 is positioned proximate the suspension features 877 in the outlet section 876. Inclusion of placement feature(s) can enhance the ability to both recognize when outlet aperture formation is to occur (trigger/trim), and also enhance ability to confirm proper placement has occurred (inspection).

These trigger or placement features are examples only and it is recognized that other suitable trigger or placement features or indicia could be used to assist with outlet aperture placement.

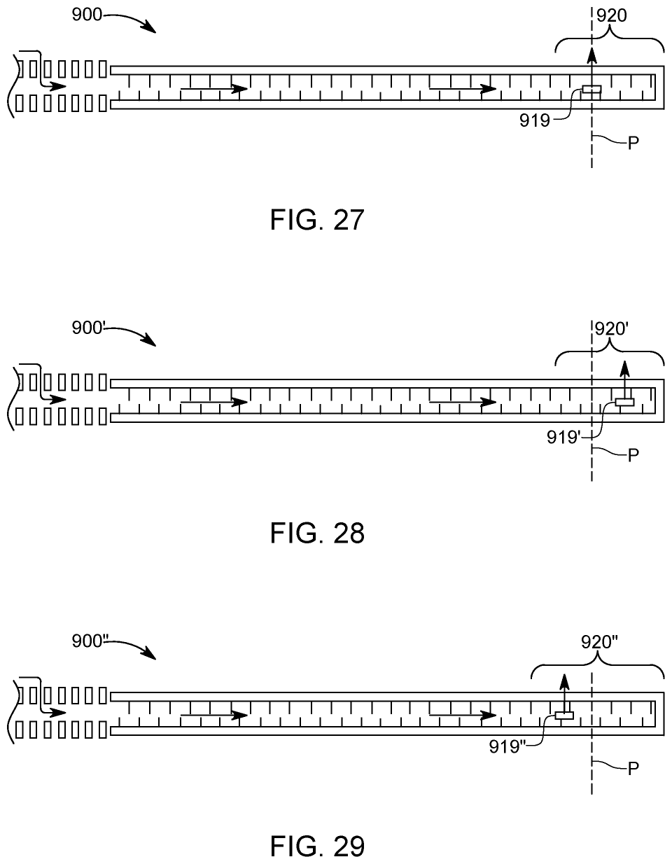

The inclusion of suspension features in the outlet section additionally enables fine tuning of flow rates. Factors such as material variations, speed differences (machine to machine, or wall thickness to wall thickness), and mold condition can lead to slight shifts in emitter flow rates established during production. Placement of the outlet apertures can be shifted downstream or upstream to adjust flow rates as desired, whether to adjust for manufacturing differences or desired flow rates for different applications. Examples of possible outlet aperture locations in example emitters are illustrated in FIGS. 27-38.

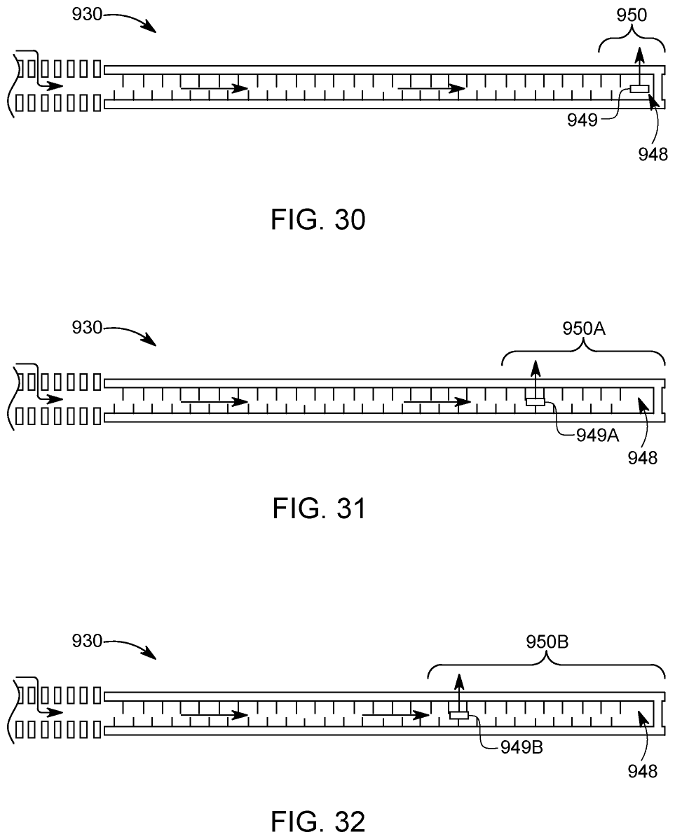

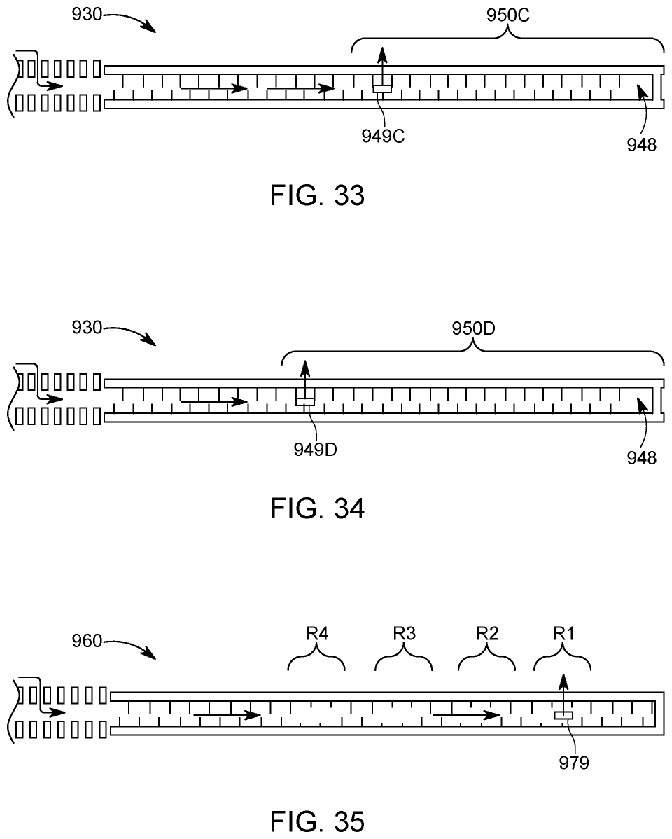

FIGS. 27-29 illustrate example emitters with suspension features within operative outlet sections, enabling ability to fine-tune flowrate by adjusting outlet section length and outlet aperture position. Emitter 900, shown in FIG. 27, includes an outlet aperture 919 positioned at position P, within operative outlet section 920. Emitter 900′, shown in FIG. 28, includes an outlet aperture 919′ positioned downstream from position P (i.e., shift flow lower), within operative outlet section 920′. Emitter 900″, shown in FIG. 29, includes an outlet aperture 919″ positioned upstream from position P (i.e., shift flow higher), within operative outlet section 920″. During emitter design, a range is identified over which the outlet aperture is desired to be placed to provide fine-tuning of flows. If for example, outlet aperture 919″ within FIG. 29 corresponded to the furthest upstream placement desired, then the pressure reducing and/or pressure responsive flow resistive features within region 920″ could be configured to additionally serve as outlet suspension features.

Whereas FIGS. 27-29 illustrate invention of fine tuning flow rates, FIGS. 30-34 illustrate invention of larger changes in emitter flow rate by adjusting the axial placement of the outlet aperture. This can be accomplished without need for emitter mold changes or for stopping a production line, thereby eliminating downtime and scrap. This is enabled by adopting pressure reducing and/or pressure responsive flow resistive features that are configured to additionally serve as outlet suspension feature geometries. FIGS. 30-34 additionally illustrate example emitters with relatively small open areas void of suspension features proximate a distal end of the outlet section. Emitter 930, shown in FIG. 30, includes an outlet aperture 949 positioned within an open area 948 proximate a distal end of an operative outlet section 950. FIG. 31 illustrates an outlet aperture 949A upstream of the open area 948 within outlet section 950A, FIG. 32 illustrates an outlet aperture 949B further upstream of the open area 948 than outlet aperture 949A and within a larger operative outlet section 950B, FIG. 33 illustrates an outlet aperture 949C further upstream of the open area 948 than outlet aperture 949B and within a larger operative outlet section 950C, and FIG. 34 illustrates an outlet aperture 949D further upstream of the open area 948 than outlet aperture 949C and within a larger operative outlet section 950D. In these examples, the flow rate of the emitter in FIG. 34 is greater than the emitter in FIG. 33, which is greater than the emitter in FIG. 32, which is greater than the emitter in FIG. 31, which is greater than the emitter in FIG. 30. Correspondingly, the operative outlet sections of 950, 950A, 950B, 950C, and 950D are successively longer. During emitter design, a range is identified over which the outlet aperture is desired to be placed to provide shifting of flow rate. If for example, operative outlet section 950D within FIG. 34 corresponded to the furthest upstream placement desired, then the pressure reducing and/or pressure responsive flow resistive features within region 950D could be configured to additionally serve as outlet suspension features. Additionally, outlet apertures may be positioned differently for different emitters within a lateral to account for different field conditions. One example may be to account for differing soil conditions. In such an example, a higher flowing emitter according to FIG. 34 may be in the lateral where field soil is sandier, and a lower flowing emitter according to FIG. 32 may be in the lateral where the field soil is less sandy. Another example may be to account for differences in pressure along the lateral. In such an example, a higher flowing emitter according to FIG. 34 may be in the lateral where pressure within the lateral is lower, and a lower flowing emitter according to FIG. 32 may be in the lateral where pressure within the lateral is higher, in so doing the flows would be more consistent than would be the case if emitters with same outlet aperture positions were used at both high and low pressure positions along the lateral. It is apparent for both of these examples that along a lateral, two or more different outlet aperture positions could be used to account for field conditions local to specific emitters within a lateral.

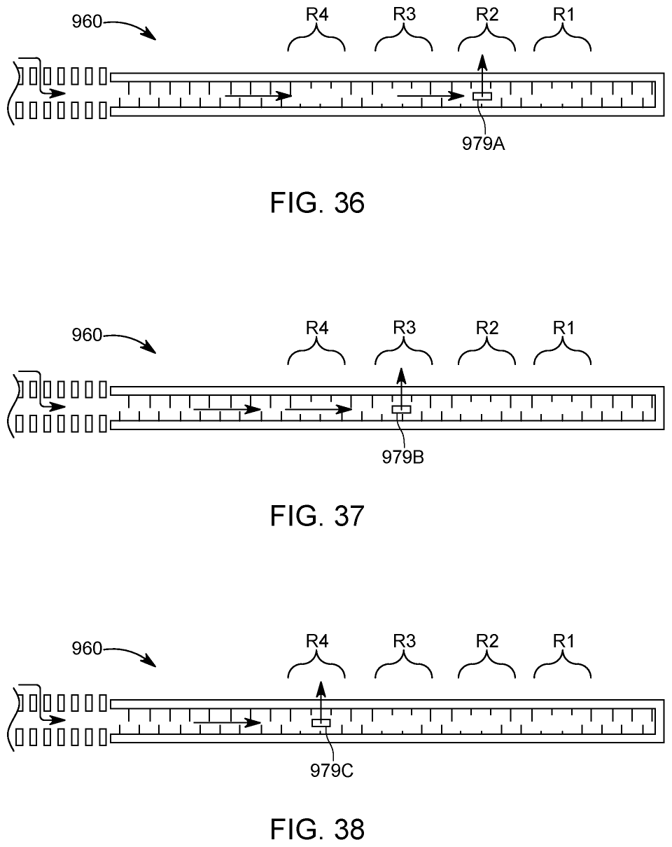

FIGS. 35-38 illustrate an example emitter design with four pre-determined outlet section regions including suspension features. Emitter 960 includes a region R1 proximate a distal end of the outlet section, a region R2 upstream of region R1, a region R3 upstream of region R2, and a region R4 upstream of region R3. In FIG. 35, an outlet aperture 979 is positioned in region R1. In FIG. 36, an outlet aperture 979A is positioned in region R2. In FIG. 37, an outlet aperture 979B is positioned in region R3. In FIG. 38, an outlet aperture 979C is positioned in region R4. Therefore, placement of the outlet aperture relative to the outlet section and its suspension features can be used to adjust flow rates, including the ability to adjust flow rates without stopping the production process or changing emitter molds (i.e. “on the fly” adjust the trigger/trim function to shift the outlet aperture axial position).

Although example configurations are shown, these are not exhaustive, and it is recognized that the various features and configurations could be interchanged and modified to accommodate different, desired results.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. An emitter for use with a lateral to form a drip irrigation lateral, the lateral having a lateral wall with an inner wall surface, at least a first portion of the lateral wall defining a lateral flow path and at least a second portion of the lateral wall defining at least one outlet aperture, the emitter comprising:
an inlet section in fluid communication with the lateral flow path, the inlet section including inlet features defining inlet apertures, the inlet features configured and arranged to filter at least some debris from irrigation water entering the inlet apertures;
at least one pressure reducing section in fluid communication with the inlet section, the at least one pressure reducing section including resistance features configured and arranged to reduce pressure in the irrigation water flowing through the at least one pressure reducing section; and
an outlet section in fluid communication with the at least one pressure reducing section and the at least one outlet aperture, wherein the inlet section, the at least one pressure reducing section, the outlet section, and a portion of the lateral wall define an emitter flow path through which the irrigation water flows;
the outlet section including at least one suspension feature configured and arranged to keep any debris in suspension in the irrigation water so that it flows out the at least one outlet aperture with the irrigation water.

2. The emitter of claim 1, wherein the at least one suspension feature is a first suspension feature having a first tip, the first tip being positioned coincident with a longitudinal axis of the outlet section.

3. The emitter of claim 1, wherein the at least one suspension feature is a first suspension feature having a first tip, the first tip being positioned not coincident with a longitudinal axis of the outlet section.

4. The emitter of claim 1, wherein the at least one suspension feature is a first suspension feature having a first tip and a second suspension feature having a second tip, the first and second suspension features extending from opposing sides of the outlet section, the first tip and the second tip being positioned in a tip arrangement from a group consisting of coincident with a longitudinal axis of the outlet section, extending beyond the longitudinal axis of the outlet section, and falling short of the longitudinal axis of the outlet section.

5. The emitter of claim 1, wherein the at least one suspension feature is a first suspension feature having a downstream edge and the outlet aperture has an upstream edge positioned upstream of the downstream edge.

6. The emitter of claim 1, wherein the at least one suspension feature is a first suspension feature having a downstream edge and the at least one outlet aperture has an upstream edge positioned coincident with the downstream edge.

7. The emitter of claim 1, wherein the at least one suspension feature is a first suspension feature having a downstream edge and the at least one outlet aperture has an upstream edge positioned 5 mm or less downstream of the downstream edge.

8. The emitter of claim 1, wherein at least a portion of the at least one suspension feature does not contact the inner wall surface.

9. The emitter of claim 1, wherein the emitter includes a floor from which opposing first and second rails extend, wherein at least a portion of the at least one suspension feature does not contact at least one of the first and second rails.

10. The emitter of claim 1, wherein the at least one suspension feature differs in at least one of angle, shape, interval length, and dimension from at least one of the resistance features.

11. The emitter of claim 1, wherein the at least one suspension feature has at least one of the same angle, same shape, same interval length, and same dimension as at least one of the resistance features.

12. The emitter of claim 1, wherein the emitter includes a floor from which opposing first and second rails extend, wherein at least a portion of at least one of the first and second rails is non-linear.

13. The emitter of claim 1, wherein the emitter includes a floor from which opposing first and second rails extend, wherein a first rail portion of the first rail is not parallel with a second rail portion of the second rail.

14. The emitter of claim 1, wherein the emitter includes a floor from which opposing first and second rails extend to interconnect the floor to the inner wall surface, wherein the floor is contoured thereby having varying distances between the floor and the inner wall surface between the first and second rails.

15. The emitter of claim 1, wherein the emitter includes a floor from which opposing first and second rails extend to interconnect the floor to the inner wall surface, wherein at least a portion of the outlet section has a first distance between the floor and the inner wall surface that differs from a second distance between the floor and the inner wall in at least a portion of one of the outlet section, the at least one pressure reducing section, or the inlet section.

16. The emitter of claim 1, wherein a first portion of the outlet section differs in width with at least a portion of one of the outlet section, the at least one pressure reducing section, or the inlet section.

17. The emitter of claim 1, wherein a first portion of the outlet section has a first outlet section centerline that is coincident with at least one of a second outlet section centerline of a second portion of the outlet section and a first pressure reducing section centerline of the at least one pressure reducing section.

18. The emitter of claim 1, wherein the pressure reducing section has a first longitudinal axis and the outlet section has a second longitudinal axis, the first longitudinal axis and the second longitudinal axis being different.

19. The emitter of claim 1, further comprising at least one trigger feature positioned in the outlet section configured and arranged to assist in positioning the at least one outlet aperture in the lateral relative to the outlet section.

20. The emitter of claim 1, wherein the at least one outlet aperture is positioned within the outlet section to adjust a flow rate of irrigation water through the at least one outlet aperture, wherein the outlet section is an operative outlet section including at least a portion of the at least one pressure reducing section or a portion of a pressure responsive section positioned between the at least one pressure reducing section and the outlet section.

21. The emitter of claim 1, wherein the at least one outlet aperture is positioned in an aperture arrangement from a group consisting of coincident with a longitudinal axis of the outlet section and not coincident with the longitudinal axis of the outlet section.

22. The emitter of claim 1, wherein the emitter is made of at least one layer including at least one material, the at least one material selected from the group consisting of an elastomeric material, a non-elastomeric material, and a combination thereof.

23. The emitter of claim 1, further comprising at least one pressure responsive section interconnecting the at least one pressure reducing section and the outlet section.

24. The emitter of claim 1, wherein the inlet section, the at least one pressure reducing section, and the outlet section extend from a floor toward the inner wall surface to define the emitter flow path.

25. The emitter of claim 1, wherein the emitter is operatively connected to the inner wall surface of the lateral wall encircled to form the drip irrigation lateral selected from the group consisting of an overlapping wall lateral, a seamless wall lateral, and a seamed wall lateral.

26. The emitter of claim 25, wherein the lateral wall is made of at least one layer including at least one material, the at least one material selected from the group consisting of an elastomeric material, a non-elastomeric material, and a combination thereof.

27. The emitter of claim 1, wherein the at least one outlet aperture includes a first outlet aperture that is not parallel to a longitudinal axis of the emitter.

28. The emitter of claim 1, wherein the at least one outlet aperture includes a first outlet aperture that is offset relative to a longitudinal axis of the emitter.

29. The emitter of claim 1, wherein the at least one outlet aperture includes a first outlet aperture that is non-linear.

30. A drip irrigation lateral, comprising:
a lateral having a lateral wall with an inner wall surface, at least a first lateral wall portion defining a lateral flow path, at least a second lateral wall portion defining at least one outlet aperture including at least a first outlet aperture and at least a second outlet aperture;
a first emitter comprising:
a first inlet section in fluid communication with the lateral flow path, the first inlet section including first inlet features defining first inlet apertures, the first inlet features configured and arranged to filter at least some debris from irrigation water entering the first inlet apertures;
at least one first pressure reducing section in fluid communication with the first inlet section, the at least one first pressure reducing section including first resistance features configured and arranged to reduce pressure in the irrigation water flowing through the at least one first pressure reducing section; and
a first outlet section in fluid communication with the at least one first pressure reducing section and the first outlet aperture, wherein the first inlet section, the at least one first pressure reducing section, the first outlet section, and a portion of the lateral wall define a first emitter flow path through which the irrigation water flows;
a second emitter comprising:
a second inlet section in fluid communication with the lateral flow path, the second inlet section including second inlet features defining second inlet apertures, the second inlet features configured and arranged to filter at least some debris from irrigation water entering the second inlet apertures;
at least one second pressure reducing section in fluid communication with the second inlet section, the at least one second pressure reducing section including second resistance features configured and arranged to reduce pressure in the irrigation water flowing through the at least one second pressure reducing section;
a second outlet section in fluid communication with the at least one second pressure reducing section and the at least one second outlet aperture, wherein the second inlet section, the at least one second pressure reducing section, the second outlet section, and a portion of the lateral wall define a second emitter flow path through which the irrigation water flows;
wherein the first emitter is in fluid communication with the first outlet aperture, the first outlet aperture having a first outlet position relative to the first outlet section, the second emitter is in fluid communication with the second outlet aperture, the second outlet aperture having a second outlet position relative to the second outlet section, the first outlet position being different than the second outlet position relative to the respective first and second outlet sections, wherein the first and second outlet apertures are positioned to adjust flow rates of irrigation water through the respective first and second outlet apertures.

31. The drip irrigation lateral of claim 30, wherein the first outlet section includes at least one first suspension feature configured and arranged to keep any debris in suspension in the irrigation water so that it flows out the first outlet aperture with the irrigation water, and wherein the second outlet section includes at least one second suspension feature configured and arranged to keep any debris in suspension in the irrigation water so that it flows out the second outlet aperture with the irrigation water.

32. The drip irrigation lateral of claim 30, wherein the first and second outlet sections are operative outlet sections including at least a portion of the respective at least one first and second pressure reducing sections or respective first and second pressure responsive sections positioned between the respective at least one first and second pressure reducing sections and the first and second outlet sections.
